(19) United States
(12) Patent Application Publication
(10) Pub. No.: US 2018/0285497 A1
(43) Pub. Date: Oct. 4, 2018

(54) Numerical Modeling and Performance Analysis of a Scramjet Engine with a Controllable Waverider Inlet Design

(71) Applicant: The Government of the United States of America, as represented by the Secretary of the Navy, Arlington, VA (US)

(72) Inventors: Gabriel B. Goodwin, Washington, DC (US); Jesse R. Maxwell, Silver Spring, MD (US)

(21) Appl. No.: 15/943,019

(22) Filed: Apr. 2, 2018

Related U.S. Application Data
(60) Provisional application No. 62/479,856, filed on Mar. 31, 2017.

(51) Int. Cl. G06F 17/50

(52) U.S. Cl. CPC G06F 17/5009; G06F 2217/16; G06F 17/5095

(57) ABSTRACT

A method for automatically determining performance characteristics of a scramjet engine uses a 1-dimensional approximation that includes obtaining a first set of environmental conditions defining freestream conditions; generating inlet outflow conditions by evaluating a change in flow from the freestream conditions across the inlet; generating isolator outflow conditions by modeling change in flow from the inlet outflow conditions across the isolator; generating combustor outflow conditions by modeling change in flow from the isolator outflow conditions across the combustor; and generating nozzle outflow conditions by modeling change in flow from combustor outflow conditions across the nozzle.

### RELATED APPLICATIONS

This application claims the benefit of U.S. Provisional Application No. 62/479,856 filed Mar. 31, 2017, which is hereby incorporated herein by reference.

### FIELD OF INVENTION

The present invention relates generally to scramjet engines, and more particularly to numerically modeling and analyzing performance of scramjet engines.

### BACKGROUND

A hypersonic waverider is a type of forebody vehicle geometry for which the oblique shock formed at the nosetip is attached along the entire leading edge and the post-shock flow is supersonic. When used as the forebody for a scramjet vehicle, improved performance is possible as the total mass flow of air passing through the leading shock is captured in the engine inlet. The waverider inlet is point-designed in that its geometry is a strong function of Mach number. Similarly, the scramjet engine is designed to operate most efficiently at a near-constant flight dynamic pressure. Maintaining a constant flight dynamic pressure while increasing altitude requires a corresponding increase in flight Mach number. To circumvent this design restriction in integrating a waverider inlet manifold on a scramjet vehicle, a morphable inner surface at the inlet may be used to maintain the point-design operation of the waverider inlet across a range of flight Mach number. However, evaluating relative performance using conventional predictive regimes is difficult.

### SUMMARY OF INVENTION

The flow through the scramjet may be modeled using a quasi-one-dimensional (quasi-1D) model, the output of which is used to predict the engine's performance parameters. The performance parameter calculations are compared to those generated through several computational fluid dynamics (CFD) simulations. The quasi-1D model is used to conduct parametric studies evaluating the performance of morphable waverider and rigid planar inlet scramjets.

According to one aspect of the invention, a method for automatically determining performance characteristics of a scramjet engine using a 1-dimensional approximation includes obtaining a first set of environmental conditions that define freestream conditions upstream of a leading edge shock of the scramjet engine; generating inlet outflow conditions by evaluating a change in flow from the freestream conditions across the inlet using oblique shock relations; generating isolator outflow conditions by modeling change in flow from the inlet outflow conditions across the isolator using analytical relations from first principles or empirical relations; generating combustor outflow conditions by modeling change in flow from the isolator outflow conditions across the combustor using analytical relations from first principles or empirical relations; generating nozzle outflow conditions by modeling change in flow from combustor outflow conditions across the nozzle using analytical relations from first principles or empirical relations; and determining performance characteristics of the scramjet engine based on a difference between freestream conditions and nozzle outflow conditions.

Optionally, the step of generating an inlet outflow condition includes the steps of generating a primary leading edge shock outflow condition by evaluating a change in flow conditions across a primary leading edge shock using oblique shock relations; and generating a secondary leading edge shock outflow condition by evaluating a change in flow conditions across a secondary leading edge shock using oblique shock relations.

Optionally, generating combustor outflow conditions includes modeling change in flow from the isolator outflow conditions across the combustor as alternating computational elements of constant-area heat addition and elements of isentropic expansion.

Optionally, a computational element size for the combustor is sufficiently small such that the pressure increases in Rayleigh flow segments do not deviate more than 1% from a constant pressure value.

Optionally, the method includes constructing a scramjet waverider geometry using a known flow field from which a waverider can be derived.

Optionally, the method includes mapping inlet conditions from the similarity solution, providing flow variable of maximum, minimum, average, and relative variation of temperature, pressure, dynamic pressure, and Mach number across inlet area; and using an inlet-area averaged value for each of the flow variables is then used as inflow for the isolator.

The foregoing and other features of the invention are hereinafter described in greater detail with reference to the accompanying drawings.

### BRIEF DESCRIPTION OF THE DRAWINGS

FIG. 1 shows a schematic of a scramjet engine with a quasi-1D flowpath streamline;

FIG. 2 shows a block diagram of an exemplary method for modeling and analyzing scramjet performance;

FIG. 3 shows quasi-1D model input parameters for a planar inlet scramjet for near-ideal Brayton cycle performance at M∞=6 and h=30 km;

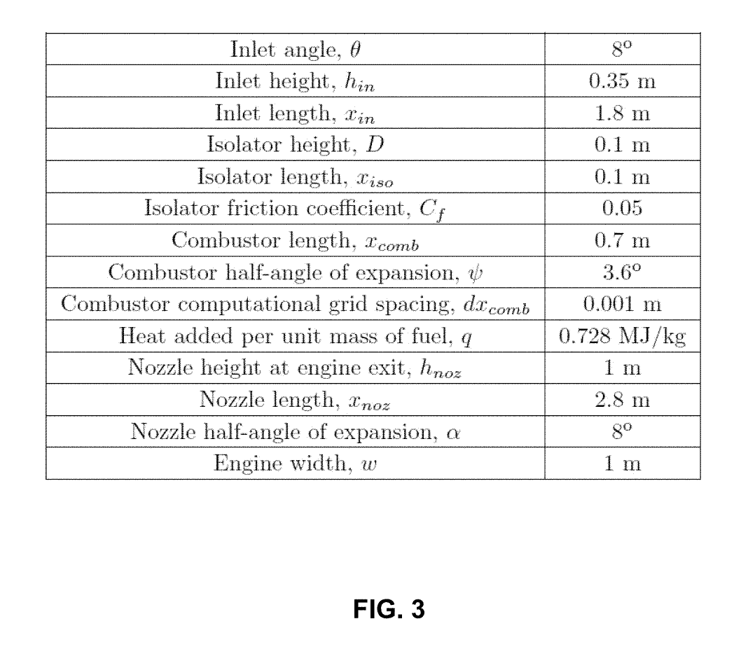

FIG. 4 shows at a) cross sectional area, at b) pressure, at c) temperature, at d) Mach number, and at e) velocity as a function of axial distance along the length of a scramjet engine with a planar inlet for M∞=6 and h=30 km. At f) is shown the engine's entropy-temperature plot;

FIG. 5 shows a generating flow field for a conical shock-derived waverider inlet (left) and resulting geometry (right).

### DETAILED DESCRIPTION

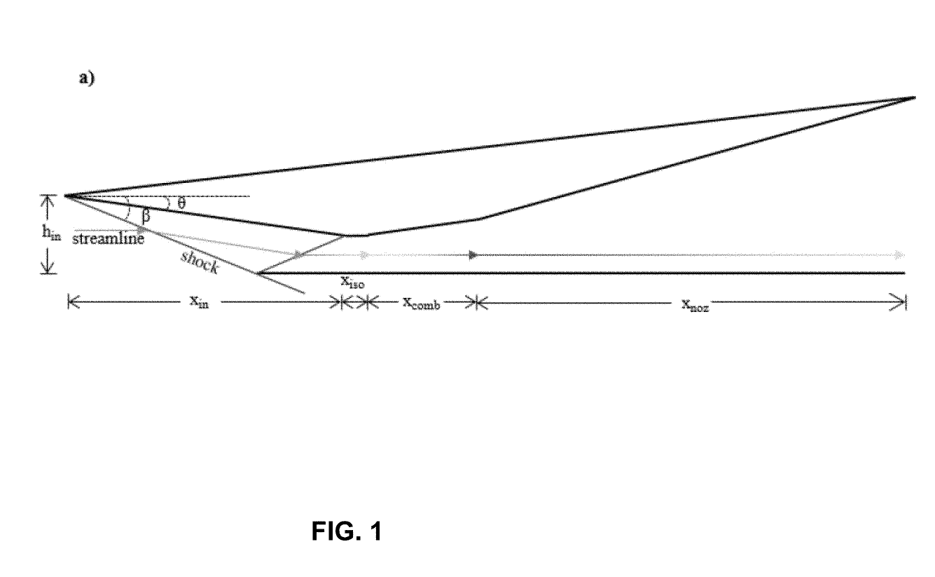

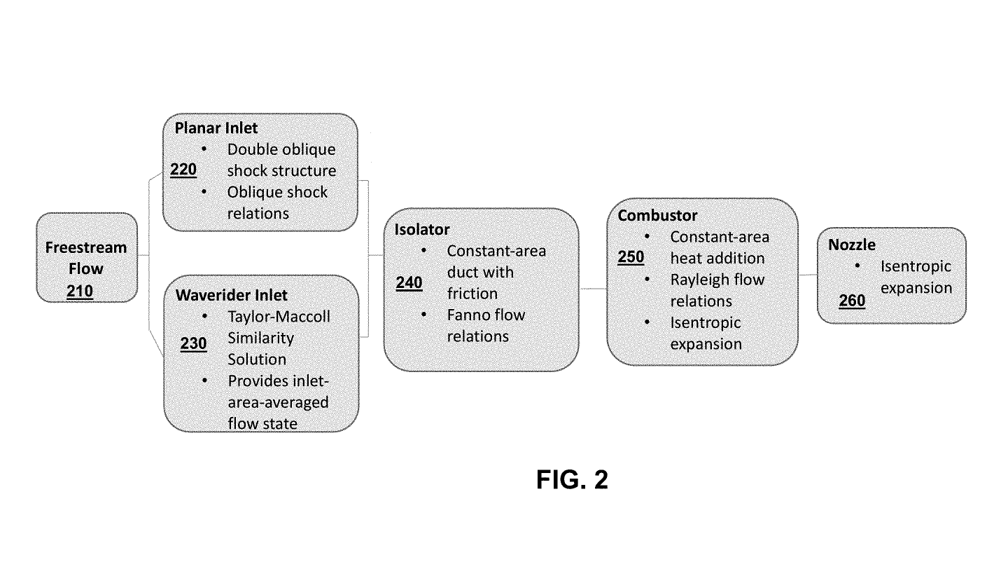

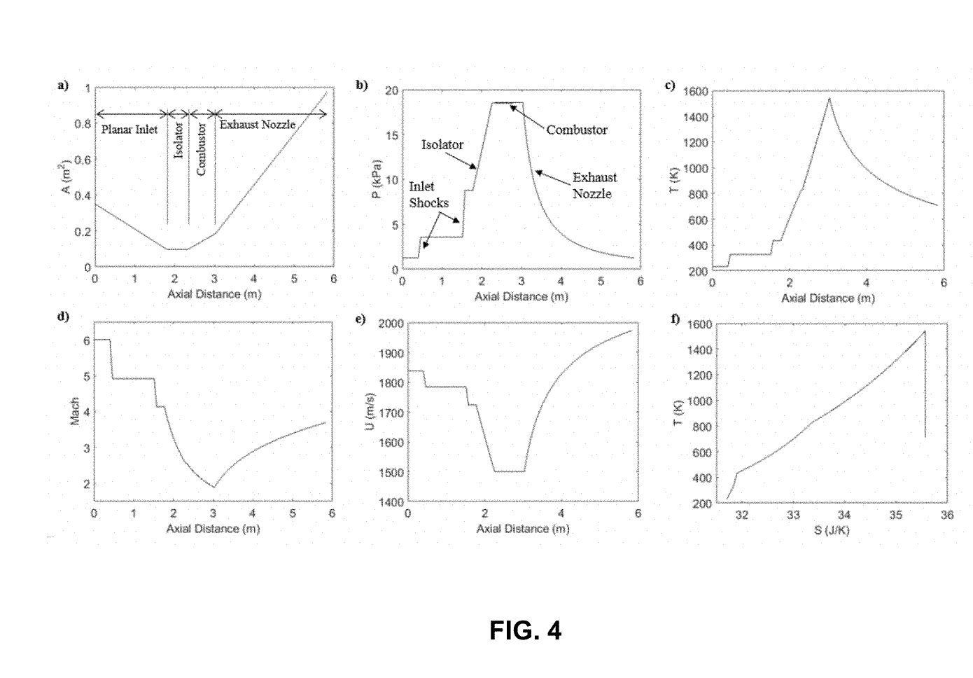

A quasi-1D approach based on first principles is used to model the flow through a scramjet engine. The state variables are computed as a function of axial distance through the engine, consisting of an inlet, isolator, combustor, and exhaust nozzle, as shown in FIG. 1. The geometry of the engine, including the inlet design and shock structure, can be modified by the user. For the purpose of the model description to follow, a planar scramjet geometry, of the type shown in FIG. 1, is used. A waverider inlet, or other three-dimensional inlet, may be used in place of a planar inlet. An example with a waverider inlet will be described later. The engine considered for the purpose of this model description is 5.83 m long with cross sectional area as a function of axial distance from the leading edge shown in FIG. 4 (in plot a), assuming a uniform engine width of 1 m. This geometry was chosen such that the model closely reflects the ideal Brayton cycle at a design point of Mach 6 cruise at 30 km. Input values required to run a simulation include M∞ and h. Additional engine parameters that may be modified to reflect different engine designs are listed in FIG. 2 the values for the parameters shown in the table of FIG. 2 correlate to those used in the simulation for this model description case. The geometric parameters listed in FIG. 2 are shown on the engine schematic in FIG. 1. Output parameters include thrust, specific thrust, thermal efficiency, and specific impulse, among others. Additionally, state variables are plotted as a function of axial distance through the engine flowpath, as shown in FIG. 4 (plots b-f).

The model, shown schematically in FIG. 2, initializes at block 210 by calculating the freestream conditions based on M∞ and h. Freestream conditions are taken as the flow conditions upstream of the vehicle's leading shock. These are obtained from the 1976 US Standard Atmosphere Survey. The air then passes through two shocks formed by the planar inlet, as shown in FIG. 1. At block 220, the first shock is formed at an angle β from horizontal by the inlet wedge with angle θ. A streamline of air passing through the first shock is turned downward by the wedge angle, θ. At block 230, a secondary shock is formed as the leading shock reflects from the lip of the inlet. The streamline passes through the secondary shock, turning upward to horizontal by angle θ. The leading edge shock angle, β, is calculated by the θ-β-M relation,

$$tan θ = 2 cot β \frac{{M}_{1}^{2} {sin}^{2} β - 1}{{M}_{1}^{2} ( γ + cos β ) + 2} \qquad ( 1 )$$

where the subscript 1 indicates pre-shock (freestream) conditions and γ is the ratio of specific heats. Change in flow conditions across the leading edge shock is calculated by the oblique shock relations,

$$\begin{matrix}{M}_{n 1} = {M}_{2} sin β & ( 2 ) \\ {M}_{n 2} = \frac{{M}_{n 1}^{2} + [ 2 \text{/} ( γ - 1 ) ]}{[ 2 γ \text{/} ( γ - 1 ) ] {M}_{n 1}^{2} - 1} & ( 3 ) \\ {M}_{2} = \frac{{M}_{n 2}}{sin ( β - θ )} & ( 4 ) \\ \frac{{P}_{2}}{{P}_{1}} = 1 + \frac{2 γ}{γ + 1} ( {M}_{n 1}^{2} - 1 ) & ( 5 ) \\ \frac{{ρ}_{2}}{{ρ}_{1}} = \frac{( γ + 1 ) {M}_{n 1}^{2}}{( γ - 1 ) {M}_{n 1}^{2} + 2} & ( 6 ) \\ \frac{{T}_{2}}{{T}_{1}} = \frac{{P}_{2}}{{P}_{1}} \frac{{ρ}_{1}}{{ρ}_{2}} & ( 7 ) \\ {u}_{2} = {M}_{2} \sqrt{γ {RT}_{2}} & ( 8 )\end{matrix}$$

where the subscript n indicates normal to the shock and 2 indicates a post-shock condition, P is static pressure, ρ is density, T is temperature, u is velocity, and R is the gas constant for air. The change in flow conditions across the secondary inlet shock are calculated using the same relations. Viscous effects in the inlet, though neglected in this example, could be accounted for by using flat plate theory to estimate the surface drag force based on the surface area of the inlet and the freestream conditions.

The post-secondary shock conditions are used as the inflow conditions for the isolator section, at block 240. Isolators are designed to protect, or isolate, the inlet flow from pressure fluctuations due to heat release in the combustor in order to avoid mass-flow reduction and inlet unstart. The interaction between the boundary layers on the isolator walls and the pressure gradient along the axial length of the duct results in boundary layer separation and the formation of an oblique shock train which compresses and heats the air prior to entering the combustor. In the quasi-1D model, the isolator is modeled with Fanno flow, or flow through a constant-area duct with static pressure rise due to friction,

$$\begin{matrix}{\int }_{0}^{{x}_{iso}} \frac{4 {C}_{f}}{D} dx = {\int }_{{M}_{1}}^{{M}_{2}} \frac{2 ( 1 - {M}^{2} )}{γ {M}^{3} ( 1 + \frac{γ - 1}{2} {M}^{2} )} dM & ( 9 ) \\ \frac{{P}_{2}}{{P}_{1}} = {\frac{{M}_{1}}{{M}_{2}} [ \frac{2 + ( γ - 1 ) {M}_{1}^{2}}{2 + ( γ - 1 ) {M}_{2}^{2}} ]}^{1 / 2} & ( 10 ) \\ \frac{{T}_{2}}{{T}_{1}} = \frac{2 + ( γ - 1 ) {M}_{1}^{2}}{2 + ( γ - 1 ) {M}_{2}^{2}} & ( 11 ) \\ \frac{{ρ}_{2}}{{ρ}_{1}} = {\frac{{M}_{1}}{{M}_{2}} [ \frac{2 + ( γ - 1 ) {M}_{1}^{2}}{2 + ( γ - 1 ) {M}_{2}^{2}} ]}^{- 1 / 2} & ( 12 )\end{matrix}$$

where subscripts 1 and 2 indicate conditions at the isolator inlet and outlet, respectively, xᵢₛₒ is the isolator length, C_{f} is a friction coefficient, and D is the isolator height. Velocity at the isolator outlet is calculated by Eqn. 8. An xᵢₛₒ of 0.1 m and a C_{f} of 0.05 were selected for this model in order to produce a compression ratio (P₂=P₁) across the isolator of 2 and an M₂>2 for M∞=6 and h=30 km. This compression ratio is on the same order as that derived from an empirical relation developed by Waltrup and Billig, used for predicting compression ratio as a function of isolator length, given the same isolator geometry and in flow conditions as used in the Fanno flow calculations. The agreement with empirical data demonstrates that the parameters used in this model, C_{f} and xᵢₛₒ, are chosen such that the Fanno flow relations accurately reflect the change in flow conditions through a constant-area isolator. Alternatively, the change in flow conditions through the isolator may be calculated solely using an empirical relation such as the Waltrup and Billig empirical relation, where changes in pressure and Mach number through the isolator are calculated as a function of combustor geometry and inflow Mach number and pressure.

The flow variables at the isolator outlet are used as the inflow conditions to the combustor section, at block 250. The governing equations for 1 D flow with heat addition in a constant-area duct, the Rayleigh relations, were implemented to model the process of heat addition to the flow through combustion,

$$\begin{matrix}{T}_{o 2} = {T}_{o 1} + q \text{/} {C}_{p} & ( 13 ) \\ \frac{{T}_{o 2}}{{T}_{o 1}} = {( \frac{1 + γ {M}_{1}^{2}}{1 + γ {M}_{2}^{2}} )}^{2} {( \frac{{M}_{2}}{{M}_{1}} )}^{2} ( \frac{1 + \frac{γ - 1}{2} {M}_{2}^{2}}{1 + \frac{γ - 1}{2} {M}_{1}^{2}} ) & ( 14 ) \\ \frac{{T}_{2}}{{T}_{1}} = {( \frac{1 + γ {M}_{1}^{2}}{1 + γ {M}_{2}^{2}} )}^{2} {( \frac{{M}_{2}}{{M}_{1}} )}^{2} & ( 15 ) \\ \frac{{ρ}_{2}}{{ρ}_{1}} = ( \frac{1 + γ {M}_{1}^{2}}{1 + γ {M}_{2}^{2}} ) {( \frac{{M}_{2}}{{M}_{1}} )}^{2} & ( 16 )\end{matrix}$$

where subscripts 1 and 2 indicate conditions at the combustor inlet and outlet, respectively, Tₒ is stagnation temperature, q is heat added per unit mass of fuel, and Cₚ is the specific heat of the air at constant pressure. For the validation of this model, a q of 0.728 MJ/kg was selected, to reflect the heat addition to the air flow that would be expected for complete combustion of JP-7 fuel.

To model the constant-pressure combustion process inherent to the ideal Brayton engine cycle, as shown in FIG. 1, the combustor is discretized into alternating computational elements of constant-area heat addition, modeled with Eqns. 13-16, and elements of isentropic expansion. The same value of q is used in each Rayleigh flow element to model a uniform heat addition to the flow along the combustor length. After heat is added to the flow in the Rayleigh segment, increasing p and T, that flow is expanded until p decreases to its value prior to the heat addition in order to maintain constant pressure through the combustor. Isentropic expansion is modeled using the following relations,

$$\begin{matrix}{( \frac{{A}_{1 , 2}}{{A}^{*}} )}^{2} = {\frac{1}{{M}_{1 , 2}^{2}} [ \frac{2}{γ + 1} ( 1 - \frac{γ - 1}{2} {M}_{1 , 2}^{2} ) ]}^{( γ + 1 ) / ( γ - 1 )} & ( 17 ) \\ {A}_{2} = w ( D + 2 tan ψ ( {x}_{2} - {x}_{comb , in} ) ) & ( 18 ) \\ {P}_{2} = {{P}_{o 2} ( 1 + \frac{γ - 1}{2} {M}_{2}^{2} )}^{γ / ( γ - 1 )} & ( 19 ) \\ {T}_{2} = {{T}_{o 2} ( 1 + \frac{γ - 1}{2} {M}_{2}^{2} )}^{- 1} & ( 20 ) \\ {P}_{o 2} = {P}_{o 1} & ( 21 ) \\ {T}_{o 2} = {T}_{o 1} & ( 22 ) \\ {ρ}_{2} = \frac{{P}_{2}}{{RT}_{2}} & ( 23 )\end{matrix}$$

where A is cross-sectional area, w is the engine width (assumed constant), x is position along the axial length of the engine, X_{comb,in} is the position of the combustor in flow along the axial length of the engine, ψ is the half-angle of expansion for the combustor, the subscripts 1 and 2 indicate conditions at the inflow and outflow of the isentropic expansion element, respectively, the subscript o represents a stagnation condition, and the superscript * indicates a condition at the point where the flow is choked to sonic (M_{local}=1) if the flow was allowed to expand to this point. Since A₁ and M₁ are known, they are substituted into Eqn. 17 to solve for A*. A value for ψ, was chosen such that, for M∞=6 and h=30 km, P is constant through the combustor, as shown in FIG. 4. After solving for A₂ using Eqn. 18, the model then solves for M₂ using Eqn. 17 and the remaining flow variables can subsequently be calculated using Eqns. 19-23. Equations 21 and 22 are valid due to the stagnation conditions remaining constant during isentropic expansion of a flow. In the sample output shown in FIG. 4, the computational element size for the combustor, dx_{comb}, is kept sufficiently low such that the pressure increases in the Rayleigh flow segments to not deviate more than 1% from the constant pressure value of 18.5 kPa. Once the flow through the entire combustor has been calculated, the fuel-to-air ratio, f, is calculated by

$$f = \frac{{T}_{o 2} - {T}_{o 1}}{\frac{h}{{C}_{p}} - ( {T}_{o 2} - {T}_{o 1} )} \qquad ( 24 )$$

where h is the heating value of the fuel and the subscripts 1 and 2 denote the combustor inflow and outflow, respectively. Using an h of 43.5 MJ/kg for JP-7, an f value of 0.017 is obtained for the sample output shown in FIG. 4. The fuel used in this work, JP-7, is a highly refined kerosene, consisting of a blend of hydrocarbons, but primarily C10H22, C12H26, and C10H20.16 The general expression for the stoichiometric fuel-to-air ratio of a given fuel is,

$${f}_{st} = \frac{36 {n}_{C} + 3 {n}_{H}}{103 ( 4 {n}_{C} + {n}_{H} )} \qquad ( 25 )$$

where n_{C} is the number of carbon atoms and n_{H} is the number of hydrogen atoms in the fuel. Taking the mean of fₛₜ for the three primary constituents of JP-7 yields an overall fₛₜ of 0.0672. The equivalence ratio, φ may be calculated by φ=f/fₛₜ, which for the case of this combustor is 0.25. Thus, the combustor in this sample simulation is running at a fuel-lean condition, which is advantageous for minimizing soot formation and excessive engine temperature.

An alternative to this method of calculating the flow through the combustor using constant-area heat addition and isentropic expansion is to use models that describe the processes occurring in ducts with heat addition and supersonic inlet conditions based on experimental results. These empirical relations may include the effects of heat transfer to the combustor walls, near-wall flow separation, mixing, viscous dissipation, and other features that increase the accuracy of the calculation while still remaining more computationally efficient than a full solution of the chemically reactive Navier-Stokes equations.

At block 260, the planar exhaust nozzle is also modeled as an isentropically expanding flow. Equations 17 and 19-23 are used to compute the flow through the nozzle. Cross-sectional area along the nozzle length is calculated by

A₂=A₁+2ωtanα(x₂−x₁) (26)

where the subscripts 1 and 2 indicate conditions at the inflow and outflow of the nozzle and α is the half-angle of expansion. In the sample output shown in FIG. 4, the flow is expanded by α=8° until P₂=P∞ to achieve a pressure-matched nozzle design. For the purpose of this example solution, viscous effects in the exhaust nozzle are neglected. To include viscous effects in the nozzle calculation, a friction factor could be applied to the first principle equations describing the flow, such as in the Fanno relations discussed in the isolator flowfield calculation. Alternatively, viscous effects could be accounted for using flat plate theory to compute the drag force on a flat plate having the same surface area and inflow conditions as the nozzle to estimate the drag through the nozzle section.

In addition to the plots shown in FIG. 4, the model outputs the following performance parameters:

$$\begin{matrix}τ = {\dot{m}}_{e} {u}_{e} - {\dot{m}}_{a} {u}_{a} + {A}_{e} ( {P}_{e} - {P}_{∞} ) & ( 27 ) \\ {τ}_{sp} = \frac{τ}{{\dot{m}}_{a}} & ( 28 ) \\ {C}_{T} = \frac{τ}{\frac{1}{2} {ρ}_{∞} {u}_{∞}^{2} {A}_{a}} & ( 29 ) \\ SFC = \frac{{\dot{m}}_{f}}{τ} & ( 30 ) \\ {I}_{sp} = \frac{τ}{{\dot{m}}_{f} g} & ( 31 ) \\ {η}_{th} = \frac{\frac{1}{2} {\dot{m}}_{e} {u}_{e}^{2} - \frac{1}{2} {\dot{m}}_{a} {u}_{∞}^{2}}{{\dot{m}}_{f} h} & ( 32 ) \\ {η}_{pr} = \frac{2}{\sqrt{{η}_{th} \frac{fh}{{u}_{∞} \text{/} 2} + 1} + 1} & ( 33 )\end{matrix}$$

where τ is thrust, \dot{m} is mass flowrate, τₛₚ is specific thrust, C_{T} is thrust coefficient, SFC is specific fuel consumption, Iₛₚ is specific impulse, g is the gravitational constant, subscript e denotes an exhaust nozzle exit condition, subscript a denotes an engine inlet (pre-combustion) condition, subscript f denotes fuel, and subscript ∞ denotes a freestream condition.

Output of the exemplary model shows agreement with typical values of a hydrocarbon-fueled scramjet cruising at Mach 6. Validation of the exemplary quasi-1D model's predictions through comparison to viscous computational fluid dynamics (CFD) solutions at multiple freestream conditions was also obtained. CFD cases were run at flight speeds of Mach 4, 6, and 7 at altitudes of 25 km, 30 km, and 40 km, respectively. The quasi-1D model, in all three cases, comes within 15% error when compared to the viscous CFD result. The model slightly over-predicts τ for the Mach 4 and Mach 7 cases, while under-predicting for the Mach 6 case; this dispersion is preferred to a consistent over or under-prediction. The ϵ values are considered to be within sufficient bounds for a high-level prediction of engine performance trends across a broad range of freestream conditions. The quasi-1D model requires only a very small fraction of the computational resources required for the viscous CFD solution. The M∞=6 and h=30 km CFD simulation required 1,150 CPU-hours to converge while the quasi-1D calculation completed in 15 seconds, running in serial on one CPU.

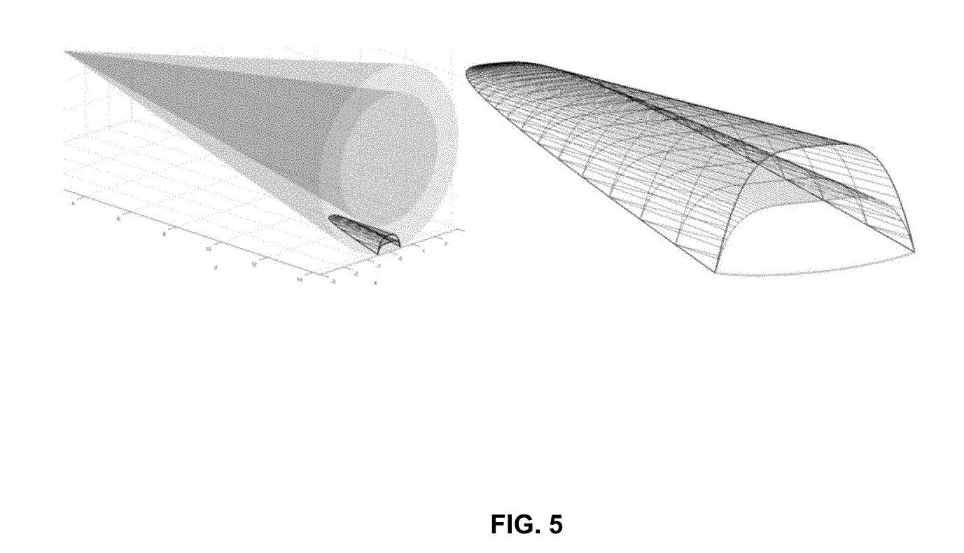

In addition to using a planar inlet geometry, the quasi-1D model can compute the inlet conditions using a waverider inlet geometry. The inviscid Taylor-Maccoll-Maccoll similarity solution for the supersonic flow field about an axisymmetric cone at a zero angle of attack is used as the methodology for constructing the waverider geometry, however any known flow field may be used (such as, e.g., a wedge, cone, or power-law body). A detailed description of this process may be found in AIAA Paper No. 2016-4706. FIG. 5 shows an example of a waverider geometry generated using this method, as well as the conical flow field that is used to generate the leading edge shock. The inlet conditions are then mapped from the similarity solution, providing the maximum, minimum, average, and relative variation of the temperature, pressure, dynamic pressure, and Mach number across the inlet area. An inlet-area averaged value for each of the flow variables is then used as the inflow for the isolator, with the remainder of the calculation following the same steps detailed above.

The quasi-1D model may be used to efficiently perform parametric studies of morphable waverider and planar inlet scramjets across a range of flight conditions, as will be described below. When running a study with a waverider inlet, the shape of the inner stream surface is recalculated at every M∞ to maintain shock attachment. The rest of the engine's geometry is fixed and does not change as a function of freestream conditions.

The exemplary model was used to characterize a scramjet's performance within a design envelope from Mach 5 to 8 and altitudes from 20 to 50 km (flight dynamic pressures from 1 to 122 kPa). A parametric study was performed to map performance across the design envelope for rigid planar and morphable waverider inlet scramjets. The planar inlet geometry is the same as was used to derive the plots shown in FIG. 4, with the typical two oblique shock structure as shown in FIG. 1. For the first waverider design, the Mach number downstream of the planar inlet shocks, at the inflow to the isolator, Mₚₗ, was used as a constraint to derive the geometry using the Taylor-Maccoll similarity solution. The shock angle was chosen such that, at a design point of M∞=6 and h=30 km, the waverider inlet-area averaged Mach number, M_{wr}, matched Mₚₗ. In other words, the waverider inlet was designed to provide the isolator with the same inflow Mach number as the planar inlet for the freestream conditions of M∞=6 and h=30 km. The waverider inlet design is able to match the planar inlet Mach number very closely for these freestream conditions, where Mₚₗ=M_{wr}=4.13. Simulations were then run with both inlet designs across the entire design envelope such that their performance could be compared. As discussed above, the geometry of the waverider upper surface is fixed across the design envelope. The inner stream surface moves in (away from the shock) as Mach number decreases or out (towards the shock) as Mach number increases in order to maintain shock attachment at the leading edge of the waverider inlet manifold.

Through morphing of the inlet, the waverider scramjet is able to maintain the Mach number at the isolator inflow such that it stays close to its value at the design point of M∞=6 and h=30 km. For M∞ from 5 to 8 at a constant h=30 km, M_{wr} varied from 3.77 to 4.64, as opposed to Mₚₗ which varied from 3.58 to 5.05. This close matching of Mach number comes at the expense of greater difference between pressure at the isolator inflow for the two inlet design cases. At M∞=6 and h=30 km, Pₚₗ=8.764 kPa, Tₚₗ=433 K, P_{wr}=10.643 kPa, and T_{wr}=433 K, where the subscripts pl and wr signify conditions at the inflow to the isolator for the planar and waverider inlet scramjets, respectively. Thus, matching Mₚₗ=M_{wr} also resulted in Tₚₗ=T_{wr}. To generate a waverider geometry that was optimized to match pressure (P_{wr}=Pₚₗ), a smaller shock angle was chosen for the Taylor-Maccoll solution.

The performance parameter of thrust normalized by dynamic pressure, τ=q∞, is of particular importance. In this work, τ refers to the uninstalled thrust generated by the engine, as no drag force on the vehicle or the engine is considered in its calculation. Thus, when τ is equal to the drag force on the vehicle, F_{D}, the scramjet maintains steady cruise. Drag force is expressed as

$$\begin{matrix}{F}_{D} = \frac{1}{2} ρ {υ}^{2} {C}_{D} A = {q}_{∞} {C}_{D} A & ( 34 ) \\ \frac{{F}_{D}}{{q}_{∞}} = {C}_{D} A & ( 35 )\end{matrix}$$

where C_{D} is the drag coefficient and A is a representative surface area. Since τ=F_{D} results in steady cruise, τ>F_{D} results in acceleration or climbing in altitude, and τ<F_{D} results in deceleration or falling in altitude. Thus, the parameter τ/q∞ may be thought of as thrust in excess of what is required for steady cruise, if τ/q∞ is greater than C_{D}A. It is important to note that the parameter C_{D}A is inherent to the vehicle's design.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A method for automatically determining performance characteristics of a scramjet engine using a 1-dimensional approximation comprising:
obtaining a first set of environmental conditions that define freestream conditions upstream of a leading edge shock of the scramjet engine;
generating inlet outflow conditions by evaluating a change in flow from the freestream conditions across the inlet using oblique shock relations;
generating isolator outflow conditions by modeling change in flow from the inlet outflow conditions across the isolator using analytical relations from first principles or empirical relations;
generating combustor outflow conditions by modeling change in flow from the isolator outflow conditions across the combustor using analytical relations from first principles or empirical relations;
generating nozzle outflow conditions by modeling change in flow from combustor outflow conditions across the nozzle using analytical relations from first principles or empirical relations; and
determining performance characteristics of the scramjet engine based on a difference between freestream conditions and nozzle outflow conditions.

2. The method of claim 1, wherein the step of generating an inlet outflow condition includes the steps of:
generating a primary leading edge shock outflow condition by evaluating a change in flow conditions across a primary leading edge shock using oblique shock relations; and
generating a secondary leading edge shock outflow condition by evaluating a change in flow conditions across a secondary leading edge shock using oblique shock relations.

3. The Method of claim 1, wherein generating combustor outflow conditions includes modeling change in flow from the isolator outflow conditions across the combustor as alternating computational elements of constant-area heat addition and elements of isentropic expansion.

4. The method of claim 3, wherein a computational element size for the combustor is sufficiently small such that the pressure increases in Rayleigh flow segments do not deviate more than 1% from a constant pressure value.

5. The method of claim 1, further comprising the step of:
constructing a scramjet waverider geometry using a known flow field from which a waverider can be derived.

6. The method of claim 5, further comprising the step of:
mapping inlet conditions from the similarity solution, providing flow variable of maximum, minimum, average, and relative variation of temperature, pressure, dynamic pressure, and Mach number across inlet area;
using an inlet-area averaged value for each of the flow variables is then used as inflow for the isolator.
